(19) United States
(12) Patent Application Publication
(10) Pub. No.: US 2023/0032829 A1
(43) Pub. Date: Feb. 2, 2023

(54) DRIVING DIAGNOSTIC DEVICE AND DRIVING DIAGNOSTIC METHOD

(71) Applicant: TOYOTA JIDOSHA KABUSHIKI KAISHA, Aichi-ken (JP)

(72) Inventor: Yukiya KUSHIBIKI, Gifu-shi (JP)

(21) Appl. No.: 17/833,898

(22) Filed: Jun. 7, 2022

(30) Foreign Application Priority Data
Jul. 30, 2021 (JP) 2021-126051

(51) Int. Cl. G07C 5/08

(52) U.S. Cl. CPC G07C 5/0808; G07C 5/0816

(57) ABSTRACT

A data acquisition unit that is able to acquire, from a vehicle, a detection value indicating that a turn signal lever provided in the vehicle is moved from a neutral position to an operation position and a specific acceleration that is at least one of front-rear acceleration of the vehicle and a steering angular acceleration of a steering wheel provided in the vehicle, and an event identification unit that determines whether a duration that is a time during which the turn signal lever is continuously positioned at the operation position is less than a first threshold value and an absolute value of the specific acceleration is equal to or more than a second threshold value based on the detection value and the specific acceleration acquired by the data acquisition unit are provided.

### CROSS-REFERENCE TO RELATED APPLICATION

This application claims priority to Japanese Patent Application No. 2021-126051 filed on Jul. 30, 2021, incorporated herein by reference in its entirety.

### BACKGROUND

### 1. Technical Field

The present disclosure relates to a driving diagnostic device and a driving diagnostic method.

### 2. Description of Related Art

Japanese Unexamined Patent Application Publication No. 2013-216214 (JP 2013-216214 A) describes the disclosure capable of prompting a driver of a vehicle to start an operation of a turn signal lever by a predetermined time (three seconds) before the scheduled time for executing a predetermined driving operation. The technical concept disclosed in JP 2013-216214 A can be applied to a driving diagnostic device. That is, it is possible to construct a driving diagnostic device that issues a negative diagnostic result when the time during which the turn signal lever is positioned at the operation position is shorter than a predetermined time.

### SUMMARY

The above-mentioned driving diagnostic device always issues negative diagnostic results when the time during which the turn signal lever is positioned at the operation position is shorter than a predetermined time. However, the negative diagnostic results may include diagnostic results that are less necessary to be determined as negative results.

In consideration of the above fact, it is an object of the present disclosure to obtain a driving diagnostic device and a driving diagnostic method capable of issuing a negative diagnostic result for the operation of the turn signal lever that is highly necessary to issue a negative diagnostic result without issuing a negative diagnostic result for the operation of the turn signal lever that is less necessary to issue a negative diagnostic result.

A driving diagnostic device according to claim 1 includes: a data acquisition unit that is able to acquire, from a vehicle, a detection value indicating that a turn signal lever provided in the vehicle is moved from a neutral position to an operation position and a specific acceleration that is at least one of a front-rear acceleration of the vehicle and a steering angular acceleration of a steering wheel provided in the vehicle; and an event identification unit that determines whether a duration that is a time during which the turn signal lever is continuously positioned at the operation position is less than a first threshold value and whether an absolute value of the specific acceleration is equal to or more than a second threshold value based on the detection value and the specific acceleration acquired by the data acquisition unit.

The data acquisition unit of the driving diagnostic device according to claim 1 is able to acquire, from the vehicle, the detection value indicating that the turn signal lever provided in the vehicle is moved from the neutral position to the operation position and the specific acceleration that is at least one of the front-rear acceleration of the vehicle and the steering angular acceleration of the steering wheel provided in the vehicle. Further, the event identification unit of the driving diagnostic device determines whether the duration that is the time during which the turn signal lever is continuously positioned at the operation position is less than the first threshold value and whether the absolute value of the specific acceleration is equal to or more than the second threshold value based on the detection value and the specific acceleration acquired by the data acquisition unit.

When the absolute value of the specific acceleration is equal to or more than the second threshold value and the duration of the turn signal lever is less than the first threshold value, it is highly necessary to issue a negative diagnostic result. On the other hand, when the absolute value of the specific acceleration is less than the second threshold value, it is less necessary to issue a negative diagnostic result in the case where the duration of the turn signal lever is less than the first threshold value. As described above, the driving diagnostic device according to claim 1 determines whether the duration of the turn signal lever is less than the first threshold value and whether the absolute value of the specific acceleration is equal to or more than the second threshold value. Therefore, the driving diagnostic device according to claim 1 can issue a negative diagnostic result for the operation of the turn signal lever that is highly necessary to issue a negative diagnostic result without issuing a negative diagnostic result for the operation of the turn signal lever that is less necessary to issue a negative diagnostic result.

The driving diagnostic device according to the disclosure indicated in claim 2 further includes, in the disclosure according to claim 1, a notification device that notifies a driver of the vehicle of a determination result by the event identification unit when the event identification unit determines that the duration is less than the first threshold value and the absolute value of the specific acceleration is equal to or more than the second threshold value.

In the disclosure according to claim 2, when the event identification unit determines that the duration is less than the first threshold value and the absolute value of the specific acceleration is equal to or more than the second threshold value, the notification device notifies the driver of the vehicle of the determination result by the event identification unit. That is, even when the duration is less than the first threshold value, the notification device does not issue a notification to the driver in the case where the absolute value of the specific acceleration is less than the second threshold value. Therefore, the notification device does not notify the driver of the determination result related to the operation of the turn signal lever executed by the driver when the absolute value of the specific acceleration is less than the second threshold value.

In the driving diagnostic device according to the disclosure indicated in claim 3, in the disclosure according to claim 1, the data acquisition unit is a transmission-reception unit that is able to receive the detection value and the specific acceleration from the vehicle via the Internet and able to transmit the detection value and the specific acceleration that are acquired to the event identification unit.

In the disclosure according to claim 3, the driving diagnostic device further includes the transmission-reception unit that is able to receive the detection value and the specific acceleration from the vehicle via the Internet and transmit the detection value and the specific acceleration that are acquired to the event identification unit. Thus, for example, the driving diagnostic device can be constructed as a cloud computing system.

The driving diagnostic device according to the disclosure indicated in claim 4, in the disclosure according to claim 1, further includes a database unit that stores information on whether the duration is less than the first threshold value and whether the absolute value of the specific acceleration is equal to or more than the second threshold value determined by the event identification unit, and is connected to the Internet.

In the disclosure according to claim 4, the database unit that is connected to the Internet stores the information on whether the duration is less than the first threshold value and whether the absolute value of the specific acceleration is equal to or more than the second threshold value determined by the event identification unit. Thus, a person who can access the database unit can develop an application that uses the information.

A driving diagnostic method according to the disclosure indicated in claim 5 includes: a step of acquiring, from a vehicle, a detection value indicating that a turn signal lever provided in the vehicle is moved from a neutral position to an operation position and a specific acceleration that is at least one of a front-rear acceleration of the vehicle and a steering angular acceleration of a steering wheel provided in the vehicle; and a step of determining whether a duration that is a time during which the turn signal lever is continuously positioned at the operation position is less than a first threshold value and whether an absolute value of the specific acceleration is equal to or more than a second threshold value based on the detection value and the specific acceleration.

As described above, the driving diagnostic device and the driving diagnostic method according to the present disclosure achieves a superior effect that the driving diagnostic device and the driving diagnostic method can issue a negative diagnostic result for the operation of the turn signal lever that is highly necessary to issue a negative diagnostic result without issuing a negative diagnostic result for the operation of the turn signal lever that is less necessary to issue a negative diagnostic result.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a vehicle capable of transmitting a detection value to a driving diagnostic device according to an embodiment;

FIG. 2 is a diagram showing the driving diagnostic device, the vehicle, and a mobile terminal according to the embodiment;

FIG. 3 is a control block diagram of a first server of the driving diagnostic device shown in FIG. 2;

FIG. 4 is a functional block diagram of a second server shown in FIG. 3;

FIG. 5 is a control block diagram of a third server of the driving diagnostic device shown in FIG. 2;

FIG. 6 is a functional block diagram of a fourth server of the driving diagnostic device shown in FIG. 2;

FIG. 7 is a functional block diagram of the mobile terminal shown in FIG. 2;

FIG. 8 is a diagram showing an event list;

FIG. 9 is a diagram showing a one-dimensional map representing second threshold values;

FIG. 10 is a flowchart showing a process executed by the second server;

FIG. 11 is a flowchart showing a process executed by the fourth server;

FIG. 12 is a flowchart showing a process executed by the mobile terminal shown in FIG. 2;

FIG. 13 is a diagram showing an image displayed on a display unit of the mobile terminal; and

FIG. 14 is a diagram showing an image displayed on the display unit of the mobile terminal.

### DETAILED DESCRIPTION OF EMBODIMENTS

Hereinafter, an embodiment of a driving diagnostic device 10 and a driving diagnostic method according to the present disclosure will be described with reference to the drawings.

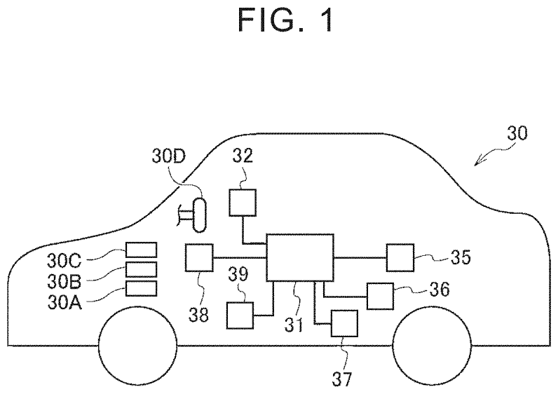

As shown in FIG. 1, a vehicle 30 capable of data communication with the driving diagnostic device 10 via a network includes an electronic control unit (ECU) 31, wheel speed sensors 32, a steering angle sensor 35, a turn signal switch 36, a global positioning system (GPS) receiver 37, a wireless communication device 38, and a camera 39. A vehicle identification (ID) is assigned to the vehicle 30 capable of receiving diagnostics by the driving diagnostic device 10. In the present embodiment, at least one vehicle 30 capable of receiving diagnostics by the driving diagnostic device 10 is manufactured by a subject A. The wheel speed sensors 32, the steering angle sensor 35, the turn signal switch 36, the GPS receiver 37, the wireless communication device 38, and the camera 39 are connected to the ECU 31. The ECU 31 includes a central processing unit (CPU), a read-only memory (ROM), a random access memory (RAM), a storage, a wireless communication interface (I/F), and an input-output I/F. The CPU, the ROM, the RAM, the storage, the communication I/F, and the input-output I/F of the ECU 31 are connected to each other so as to be able to communicate with each other via a bus. The above network includes a communication network of a telecommunications carrier and the Internet network. The wireless communication device 38 of the vehicle 30 and a mobile terminal (notification device) 50 described later perform data communication via the network. Further, as shown in FIG. 1, the vehicle 30 includes an accelerator pedal 30A, a brake pedal 30B, a turn signal lever 30C, and a steering wheel 30D. The turn signal lever 30C can rotate from a predetermined neutral position (initial position) to a first position on the upper side and a second position on the lower side.

The wheel speed sensors 32, the steering angle sensor 35, the turn signal switch 36, and the GPS receiver 37 are detection units that repeatedly detect, every time a predetermined time elapses, a physical quantity that changes based on at least one of traveling, steering, and braking of the vehicle 30 or a physical quantity that changes as a predetermined operation member (such as the accelerator pedal 30A, the brake pedal 30B, the turn signal lever 30C, and the steering wheel 30D) is operated. The vehicle 30 is provided with four wheel speed sensors 32. Each wheel speed sensor 32 detects a wheel speed of corresponding one of the four wheels of the vehicle 30. The steering angle sensor 35 detects a steering angle of the steering wheel 30D. The turn signal switch 36 detects the operation of the turn signal lever 30C. For example, when the turn signal switch 36 detects that the turn signal lever 30C is moved from a neutral position to a first position, a leftward turn signal (indicator) (not shown) that is a lighting device provided in the vehicle 30 is turned on under the control of the ECU 31. On the other hand, when the turn signal switch 36 detects that the turn signal lever 30C is moved from the neutral position to a second position, a right turn signal (indicator) (not shown) provided in the vehicle 30 is turned on under the control of the ECU 31. The GPS receiver 37 acquires information on a position where the vehicle 30 is traveling (hereinafter, referred to as “position information”) by receiving a GPS signal transmitted from a GPS satellite. The detection values detected by the wheel speed sensors 32, the steering angle sensor 35, the turn signal switch 36, and the GPS receiver 37 are transmitted to the ECU 31 via a controller area network (CAN) provided in the vehicle 30 and stored in a storage of the ECU 31. Further, the camera 39 repeatedly captures an image of an object positioned outside the vehicle 30 every time a predetermined time elapses. The image data acquired by the camera 39 is transmitted to the ECU 31 via the network provided in the vehicle 30 and is stored in the storage.

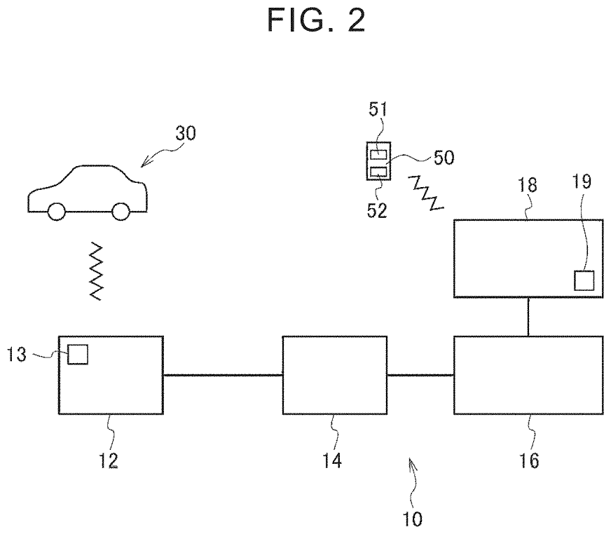

As shown in FIG. 2, the driving diagnostic device 10 includes a first server 12, a second server 14, a third server (database unit) 16, and a fourth server 18. For example, the first server 12, the second server 14, the third server 16, and the fourth server 18 are arranged in one building. The first server 12 and the fourth server 18 are connected to the above network. The first server 12 and the second server 14 are connected by a local area network (LAN). The second server 14 and the third server 16 are connected by the LAN. The third server 16 and the fourth server 18 are connected by the LAN. That is, the driving diagnostic device 10 is constructed as a cloud computing system. In the present embodiment, the first server 12, the second server 14, and the third server 16 are managed by the subject A. In contrast, the fourth server 18 is managed by a subject B.

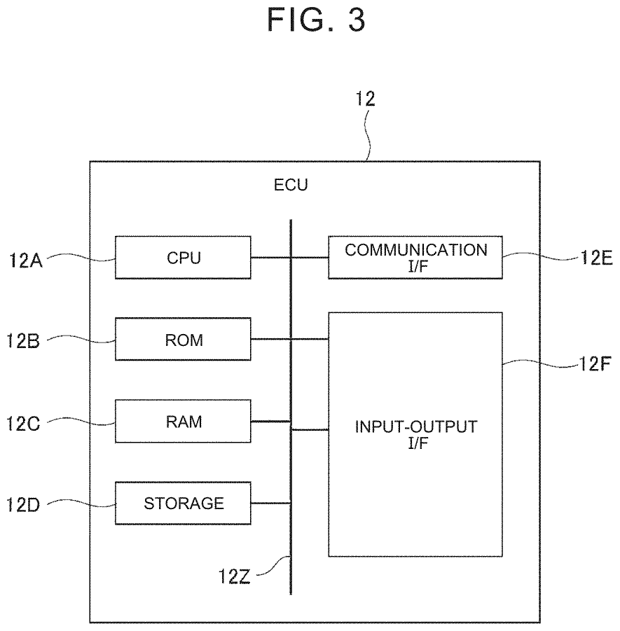

The first server 12 shown in FIG. 3 is configured to include a central processing unit (CPU: processor) 12A, a read-only memory (ROM) 12B, a random access memory (RAM) 12C, a storage 12D, a communication interface (I/F) 12E, and an input-output I/F 12F. The CPU 12A, the ROM 12B, the RAM 12C, the storage 12D, the communication I/F 12E, and the input-output I/F 12F are connected so as to be able to communicate with each other via a bus 12Z. The first server 12 can acquire information on the date and time from a timer (not shown).

The CPU 12A is a central processing unit that executes various programs and that controls various units. That is, the CPU 12A reads the program from the ROM 12B or the storage 12D and executes the program using the RAM 12C as a work area. The CPU 12A controls each configuration and executes various arithmetic processes (information processes) in accordance with the program recorded in the ROM 12B or the storage 12D.

The ROM 12B stores various programs and various data. The RAM 12C temporarily stores a program or data as a work area. The storage 12D is composed of a storage device such as a hard disk drive (HDD) or a solid state drive (SSD), and stores various programs and various data. The communication I/F 12E is an interface for first server 12 to communicate with other devices. The input-output I/F 12F is an interface for communicating with various devices.

The detection value data that is the data representing the detection values detected by the wheel speed sensors 32, the steering angle sensor 35, the turn signal switch 36, and the GPS receiver 37 of the vehicle 30 and the image data acquired by the camera 39 are transmitted from the wireless communication device 38 to a transmission-reception unit (data acquisition unit) 13 of the first server 12 via the above-described network every time a predetermined time elapses, and the detection value data and the image data are recorded in the storage 12D. All the detection value data and image data recorded in the storage 12D include information on the vehicle ID, information on an acquired time, and position information acquired by the GPS receiver 37. That is, the detection value data and the image data are associated with the information on the vehicle ID, the information on the time, and the position information.

The basic configurations of the second server 14, the third server 16, and the fourth server 18 are the same as those of the first server 12.

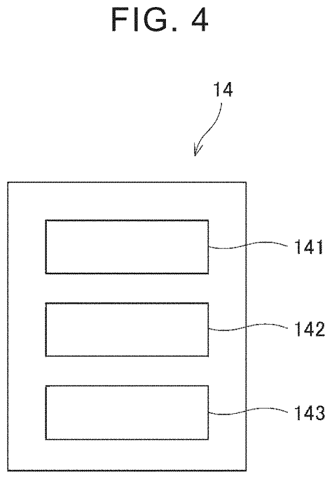

FIG. 4 is a block diagram showing an example of a functional configuration of the second server 14. The second server 14 includes a transmission-reception unit 141, an event identification unit 142, and a deletion unit 143 as functional configurations. The transmission-reception unit 141, the event identification unit 142, and the deletion unit 143 are realized as the CPU of the second server 14 reads and executes the program stored in the ROM.

The transmission-reception unit 141 transmits and receives information to and from the first server 12 and the third server 16 via the LAN. The detection value data and the image data recorded in the storage 12D of the first server 12 are transmitted to the transmission-reception unit 141 of the second server 14 while being associated with the vehicle ID, the time information, and the position information. The detection value data and the image data transmitted from the first server 12 to the transmission-reception unit 141 include a data group acquired during a predetermined data detection period. This data detection period is, for example, 30 minutes. Hereinafter, the data group (detection value data and image data) that corresponds to one vehicle ID and that is acquired during the data detection period will be referred to as a “detection value data group”. The detection value data group recorded in the first server 12 is transmitted to the transmission-reception unit 141 in order from the oldest acquired time. More specifically, as will be described later, when the detection value data group is deleted from the storage of the second server 14, a newer detection value data group than the deleted detection value data group is transmitted from the first server 12 to the transmission-reception unit 141 and this new detection value data group is stored in the storage of the second server 14.

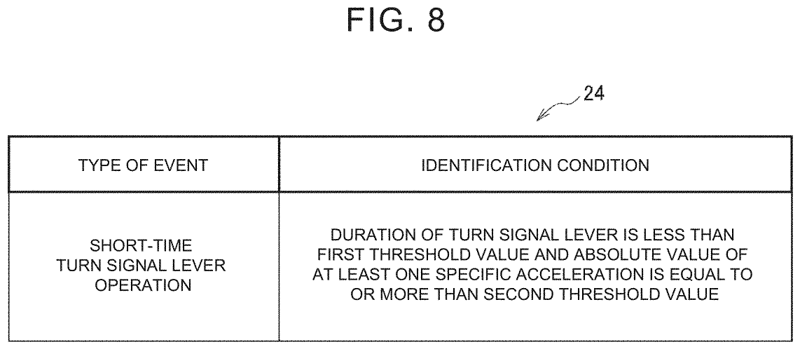

The event identification unit 142 identifies an event by referring to the detection value data group stored in the storage of the second server 14 and an event list 24 that is shown in FIG. 8 and that is recorded in the ROM of the second server 14. The event is a specific behavior that occurs in the vehicle 30 due to an operation by the driver. The event list 24 defines the type (contents) of the event and the conditions (identification conditions) for being identified as an event. The event list 24 defines a “short-time turn signal lever operation” as an event.

The event identification unit 142 determines whether the turn signal lever 30C is moved from the neutral position to the first position or to the second position, based on all the detection values of the turn signal switch 36 included in the detection value data group stored in the storage. The first position or the second position to which the turn signal lever 30C is moved may be referred to as an “operation position”. Further, when the event identification unit 142 detects that the turn signal lever 30C is moved to the operation position, the event identification unit 142 determines whether a duration that is the amount of time during which the turn signal lever 30C is continuously positioned at the operation position is less than a predetermined first threshold value, based on the information on the time at which the detection value of the turn signal switch 36 is acquired. The first threshold value is determined based on, for example, a regulation of a country where a road on which the vehicle 30 travels is present. For example, when the regulation of the above country requires the driver to position the turn signal lever 30C at the operation position for three seconds or more, the first threshold value is “three (seconds)”. The first threshold value is recorded, for example, in the ROM or storage of the second server 14.

Further, the event identification unit 142 determines whether an absolute value of a specific acceleration of the vehicle 30 is equal to or more than a second threshold value based on all the detection values detected by the wheel speed sensors 32 and the steering angle sensor 35 and included in the detection value data group stored in the storage. Here, the specific acceleration is at least one of a front-rear acceleration of the vehicle 30 and a steering angular acceleration of the steering wheel 30D.

The front-rear acceleration includes a front-rear maximum acceleration and a front-rear minimum acceleration. The front-rear maximum acceleration is the maximum front-rear acceleration detected during the duration when the event identification unit 142 determines that the duration of the turn signal switch 36 is less than the first threshold value. The front-rear minimum acceleration is the minimum front-rear acceleration detected during the duration when the event identification unit 142 determines that the duration of the turn signal switch 36 is less than the first threshold value. In other words, the front-rear minimum acceleration is the maximum front-rear deceleration detected during the duration when the event identification unit 142 determines that the duration of the turn signal switch 36 is less than the first threshold value. That is, the front-rear minimum acceleration is a negative (−) value. Note that, the front-rear acceleration is a differential value of the vehicle speed of the vehicle 30, and is calculated by the event identification unit 142. Further, the event identification unit 142 calculates the vehicle speed of the vehicle 30 based on the wheel speed that is included in the detection value data group stored in the storage of the second server 14 and that is detected by each wheel speed sensor 32.

The steering angular acceleration is a second-order differential value of the steering angle of the steering wheel 30D detected by the steering angle sensor 35, and is calculated by the event identification unit 142.

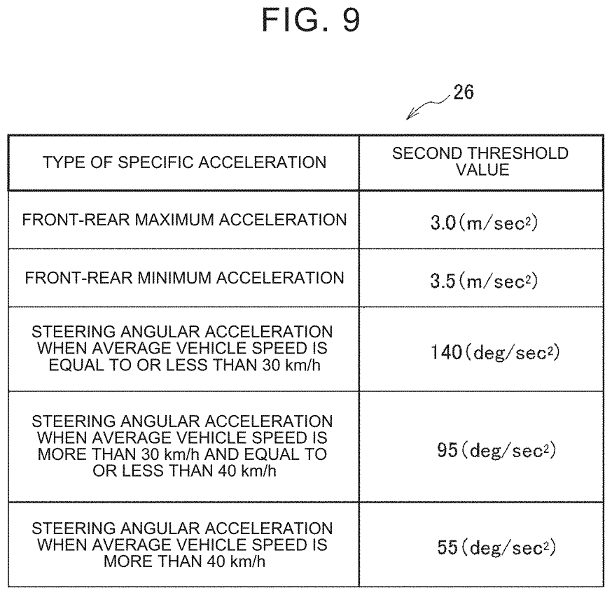

FIG. 9 shows a one-dimensional map 26 indicating the magnitude of the second threshold values. As is clear from the one-dimensional map 26, the magnitude of the second threshold value according to the present embodiment differs depending on the type of the specific acceleration. Note that, the second threshold value related to the steering angular acceleration differs depending on the magnitude of an average value of the vehicle speeds during the above duration determined to be less than the first threshold value. The event identification unit 142 calculates the average value of the vehicle speeds. The event identification unit 142 determines whether at least one of the absolute values of the front-rear maximum acceleration, the front-rear minimum acceleration, and the steering angular acceleration is equal to or more than the corresponding second threshold value.

As described above, the event identification unit 142 determines whether the duration of the turn signal lever 30C is less than the first threshold value and whether the absolute value of the specific acceleration is equal to or more than the second threshold value. Further, the event identification unit 142 identifies, as an event, the date and time when the event identification unit 142 determines that the duration of the turn signal lever 30C is less than the first threshold value and the absolute value of the specific acceleration is equal to or more than the second threshold value and the position information when this state occurs.

When the event identification unit 142 completes the above process for one detection value data group recorded in the storage, the transmission-reception unit 141 transmits the data related to the identified event to the third server 16 together with the information on the vehicle ID. The data related to the event includes information on the date and time when each of the identified events has occurred, the position information, and the image data acquired by the camera 39 within a predetermined time including the time at which the identified event has occurred.

Further, when the event identification unit 142 completes the above process for one detection value data group, the deletion unit 143 deletes the detection value data group from the storage of the second server 14.

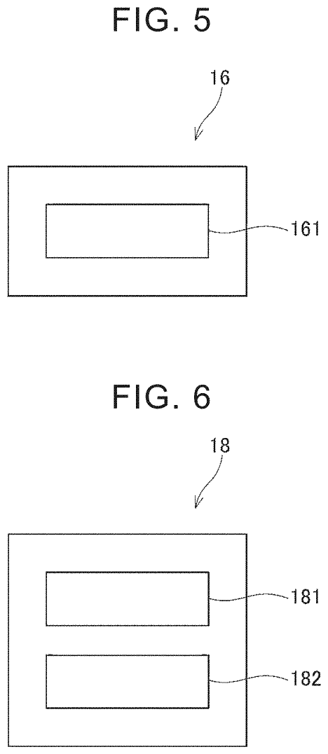

The third server 16 receives the data related to the identified event transmitted from the second server 14. As shown in FIG. 5, the third server 16 includes a transmission-reception unit 161 as a functional configuration. The transmission-reception unit 161 is realized as the CPU of the third server 16 reads and executes the program stored in the ROM. The data received by the transmission-reception unit 161 is recorded in the storage of the third server 16. The data related to the identified event is sequentially transmitted from the second server 14 to the third server 16, and the third server 16 records all the received data in the storage.

The fourth server 18 at least functions as a Web server and a web application (Web App) server. As shown in FIG. 6, the fourth server 18 includes a transmission-reception control unit 181 and a data generation unit 182 as a functional configuration. The transmission-reception control unit 181 and the data generation unit 182 are realized as the CPU of the fourth server 18 reads and executes the program stored in the ROM. The transmission-reception control unit 181 controls a transmission-reception unit 19 of the fourth server 18.

The mobile terminal 50 shown in FIG. 2 includes a CPU, a ROM, a RAM, a storage, a communication I/F, and an input-output I/F. The mobile terminal 50 is, for example, a smartphone or a tablet computer. The CPU, the ROM, the RAM, the storage, the communication I/F, and the input-output I/F of the mobile terminal 50 are connected to each other so as to be able to communicate with each other via a bus. The mobile terminal 50 can acquire information on the date and time from a timer (not shown). The mobile terminal 50 is provided with a display unit 51 including a touch panel. The display unit 51 is connected to an input-output I/F of the mobile terminal 50. Further, map data is recorded in the storage of the mobile terminal 50. The mobile terminal 50 includes a transmission-reception unit 52.

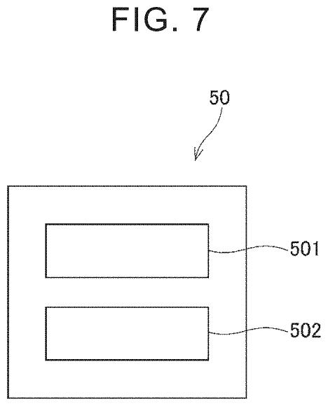

FIG. 7 is a block diagram showing an example of a functional configuration of the mobile terminal 50. The mobile terminal 50 includes a transmission-reception control unit 501 and a display unit control unit 502 as the functional configuration. The transmission-reception control unit 501 and the display unit control unit 502 are realized as the CPU reads and executes the program stored in the ROM. The mobile terminal 50 is owned by, for example, the driver of the vehicle 30 to which the vehicle ID is assigned. A predetermined driving diagnostic display application is installed on the mobile terminal 50.

The transmission-reception unit 52 controlled by the transmission-reception control unit 501 transmits and receives data to and from the transmission-reception unit 19 of the fourth server 18.

The display unit control unit 502 controls the display unit 51. That is, the display unit control unit 502 causes the display unit 51 to display, for example, the information received by the transmission-reception unit 52 from the transmission-reception unit 19 and the information input via the touch panel. The transmission-reception unit 52 can transmit the information input via the touch panel of the display unit 51 to the transmission-reception unit 19.

### Operation and Effects

Next, the operation and effects of the present embodiment will be described.

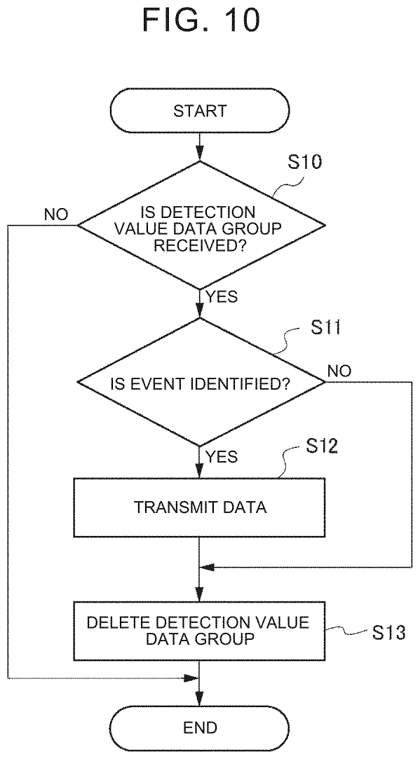

Next, the flow of the process executed by the second server 14 will be described using the flowchart shown in FIG. 10. The second server 14 repeatedly executes the process of the flowchart shown in FIG. 10 every time a predetermined time elapses.

First, in step S10, the transmission-reception unit 141 of the second server 14 determines whether the detection value data group is received from the first server 12. In other words, the transmission-reception unit 141 determines whether the detection value data group is recorded in the storage of the second server 14.

The second server 14 that determines Yes in step S10 proceeds to step S11, and the event identification unit 142 determines whether an event has occurred based on the detection value data group and the one-dimensional map 26 stored in the second server 14.

The second server 14 that determines Yes in step S11 proceeds to step S12, and the transmission-reception unit 141 transmits the data related to the identified event to the third server 16 together with the information on the vehicle ID.

When the process in step S12 is completed or when the determination is No in step S11, the second server 14 proceeds to step S13, and the deletion unit 143 deletes the detection value data group from the storage of the second server 14.

When the determination is No in step S10, or when the process in step S13 is completed, the second server 14 temporarily ends the process of the flowchart shown in FIG. 10.

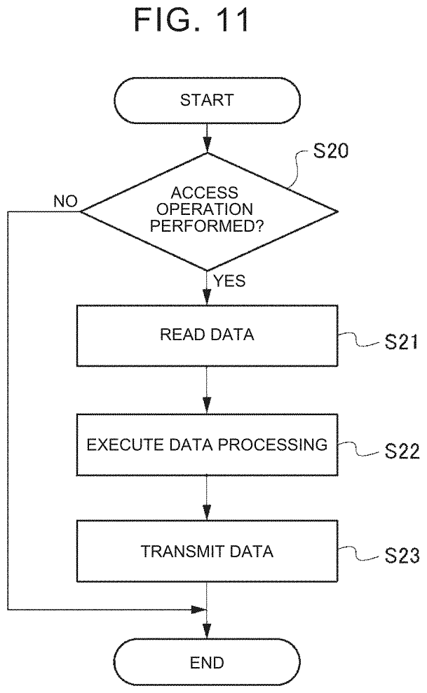

Next, the flow of the process executed by the fourth server 18 will be described with reference to the flowchart shown in FIG. 11. The fourth server 18 repeatedly executes the process of the flowchart shown in FIG. 11 every time a predetermined time elapses.

First, in step S20, the transmission-reception control unit 181 of the fourth server 18 determines whether a display request is transmitted from the transmission-reception control unit 501 (transmission-reception unit 52) of the mobile terminal 50 in which the driving diagnostic display application is running to the transmission-reception unit 19. That is, the transmission-reception control unit 181 determines whether an access operation from the mobile terminal 50 is performed. The display request includes information on the vehicle ID associated with the mobile terminal 50.

When the determination is Yes in step S20, the fourth server 18 proceeds to step S21, and the transmission-reception control unit 181 (transmission-reception unit 19) communicates with the third server 16. The transmission-reception control unit 181 (transmission-reception unit 19) receives, from the transmission-reception unit 161 of the third server 16, the data related to the identified event corresponding to the vehicle ID associated with the mobile terminal 50 from which the display request is transmitted.

The fourth server 18 that completes the process in step S21 proceeds to step S22, and the data generation unit 182 generates data representing a driving diagnostic result image 55 (see FIG. 13) using the data received in step S21. The driving diagnostic result image 55 can be displayed on the display unit 51 of the mobile terminal 50 in which the driving diagnostic display application is running.

The fourth server 18 that completes the process in step S22 proceeds to step S23, and the transmission-reception unit 19 transmits the data generated by the data generation unit 182 in step S22 to the transmission-reception control unit 501 (transmission-reception unit 52) of the mobile terminal 50.

When the determination is No in step S20, or when the process in step S23 is completed, the fourth server 18 temporarily ends the process of the flowchart shown in FIG. 11.

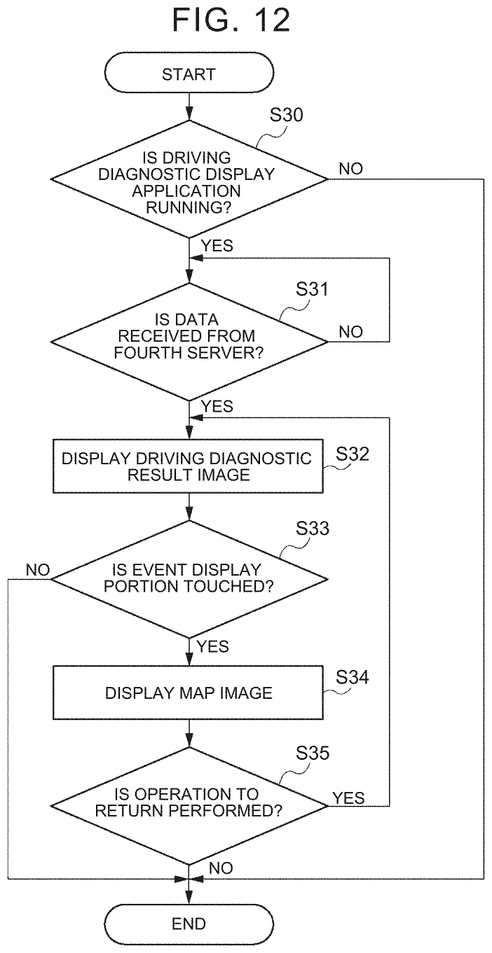

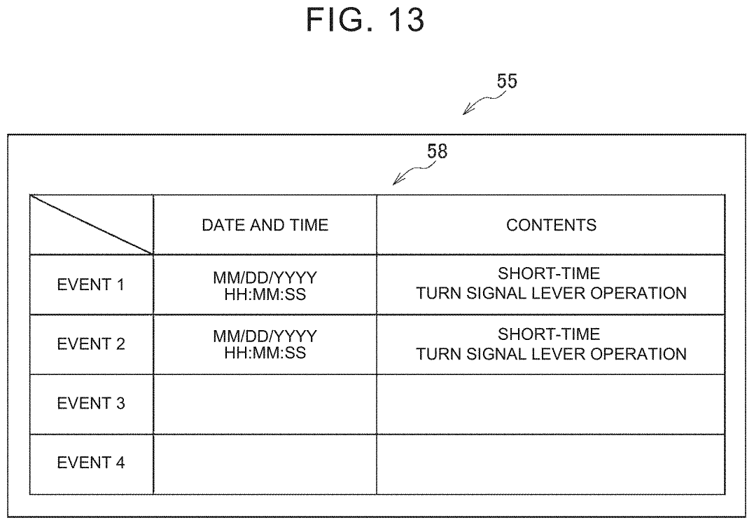

Next, the flow of the process executed by the mobile terminal 50 will be described with reference to a flowchart shown in FIG. 12. The mobile terminal 50 repeatedly executes the process of the flowchart shown in FIG. 12 every time a predetermined time elapses.

In step S30, the display unit control unit 502 of the mobile terminal 50 determines whether the driving diagnostic display application is running.

When the determination is Yes in step S30, the mobile terminal 50 proceeds to step S31, and determines whether the transmission-reception control unit 501 (transmission-reception unit 52) receives data representing the driving diagnostic result image 55 from the transmission-reception unit 19 of the fourth server 18.

When the determination is Yes in step S31, the mobile terminal 50 proceeds to step S32, and the display unit control unit 502 causes the display unit 51 to display the driving diagnostic result image 55.

As shown in FIG. 13, the driving diagnostic result image 55 includes an event display portion 58. Information on each identified event is displayed in the event display portion 58. The information representing each event includes the date and time when the event has occurred and the contents of the event.

The mobile terminal 50 that completes the process in step S32 proceeds to step S33, and the display unit control unit 502 determines whether a hand of a user of the mobile terminal 50 touches the event display portion 58 on the display unit 51 (touch panel).

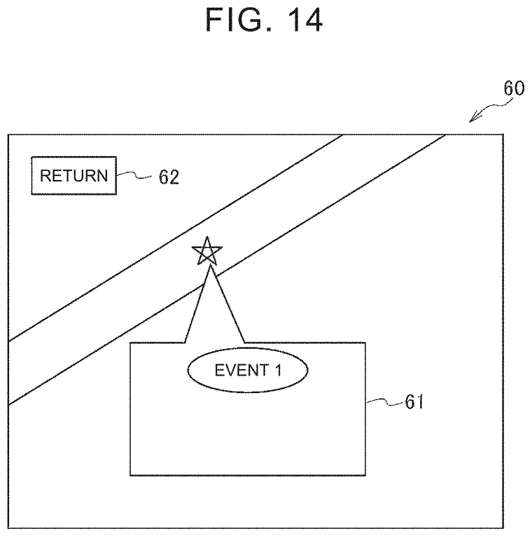

When the determination is Yes in step S33, the mobile terminal 50 proceeds to step S34, and the display unit control unit 502 causes the display unit 51 to display a map image 60 shown in FIG. 14 based on the map data above. Here, it is assumed that the driver touches the “event 1” in the event display portion 58. In this case, the map image 60 includes map information on the place where the event 1 has occurred and its surroundings, and the place where the event 1 has occurred is indicated by a star mark. Further, when the user touches the star mark, an event image 61 represented by the image data acquired by the camera 39 within a predetermined time including the time at which the event 1 has occurred is displayed. This predetermined time is, for example, 10 seconds.

The mobile terminal 50 that completes the process in step S34 proceeds to step S35, and the display unit control unit 502 determines whether a return operation portion 62 on the map image 60 is touched by the hand of the user. The display unit control unit 502 of the mobile terminal 50 that determines Yes in step S35 proceeds to step S32, and causes the display unit 51 to display the driving diagnostic result image 55.

When the determination is No in step S30, step S33, or step S35, the mobile terminal 50 temporarily ends the process of the flowchart shown in FIG. 12.

As described above, in the driving diagnostic device 10 and the driving diagnostic method according to the present embodiment, the event identification unit 142 determines whether the duration of the turn signal lever 30C is less than the first threshold value and whether the absolute value of the specific acceleration is equal to or more than the second threshold value. Then, when the event identification unit 142 determines that the duration during which the turn signal lever 30C is positioned at the operation position is less than the first threshold value and the absolute value of the specific acceleration is equal to or more than the second threshold value, the driving diagnostic result image 55 representing this fact is displayed on the display unit 51 of the mobile terminal 50. When the absolute value of the specific acceleration is equal to or more than the second threshold value and the duration of the turn signal lever 30C is less than the first threshold value, it is highly necessary to determine that the operation of the turn signal lever 30C corresponds to the “short-time turn signal lever operation” that is a negative diagnostic result. On the other hand, when the absolute value of the specific acceleration is less than the second threshold value and the duration of the turn signal lever 30C is less than the first threshold value, it is less necessary to determine that the operation of the turn signal lever 30C corresponds to the “short-time turn signal lever operation”. Therefore, the driving diagnostic device 10 and the driving diagnostic method according to the present embodiment can issue a negative diagnostic result for the operation of the turn signal lever 30C that is highly necessary to issue a negative diagnostic result without issuing a negative diagnostic result for the operation of the turn signal lever 30C that is less necessary to issue a negative diagnostic result.

Further, when the event identification unit 142 determines that the duration is less than the first threshold value and the absolute value of the specific acceleration is equal to or more than the second threshold value, the mobile terminal 50 notifies the driver of the vehicle 30 of the determination result by the event identification unit 142. That is, even when the duration is less than the first threshold value, the mobile terminal 50 does not issue a notification to the driver in the case where the absolute value of the specific acceleration is less than the second threshold value. Therefore, the mobile terminal 50 does not notify the driver of the determination result related to the operation of the turn signal lever 30C executed by the driver when the absolute value of the specific acceleration is less than the second threshold value. Accordingly, the driver who sees the mobile terminal 50 is less likely to feel annoyed.

Further, the image data included in the data group transmitted from the second server 14 to the third server 16 is only the image data when the event occurs. Therefore, the amount of data accumulated in the storage of the third server 16 is smaller than the amount of data in the case where all the image data recorded in the storage of the second server 14 is transmitted from the second server 14 to the third server 16.

Further, in the driving diagnostic device 10 and the driving diagnostic method according to the present embodiment, the subject B different from the subject A that manages the first server 12, the second server 14, and the third server 16 and that manufactures the vehicle can access the data stored in the third server 16. Thus, a person (organization) different from the subject A can create an application (driving diagnostic display application) that uses the driving diagnostic result acquired by the driving diagnostic device 10 and the driving diagnostic method according to the present embodiment. Therefore, development of such an application can be promoted.

Although the driving diagnostic device 10 and the driving diagnostic method according to the embodiment have been described above, the design of the driving diagnostic device 10 and the driving diagnostic method can be appropriately changed within a range not deviating from the scope of the present disclosure.

For example, when the event identification unit 142 determines that the duration is less than the first threshold value and the absolute value of the specific acceleration is equal to or more than the second threshold value, a sound representing the determination result may be output from a speaker provided in the mobile terminal 50 (notification device).

For example, the event identification unit 142 may determine that “the absolute value of the specific acceleration is equal to or more than the second threshold value” when the absolute values of any two or more of the front-rear maximum acceleration, the front-rear minimum acceleration, and the steering angular acceleration are equal to or more than the corresponding second threshold value.

Further, the event identification unit 142 may determine that “the absolute value of the specific acceleration is equal to or more than the second threshold value” when the absolute value of any one of the front-rear maximum acceleration, the front-rear minimum acceleration, and the steering angular acceleration is equal to or more than the corresponding second threshold value.

The ECU 31 of the vehicle 30 may have the function of the event identification unit. In this case, the detection value data and the image data acquired by the camera 39 are stored in the storage (data acquisition unit) of the vehicle 30. Further, the ECU 31 (event identification unit) determines whether the duration is less than the first threshold value and whether the absolute value of the specific acceleration is equal to or more than the second threshold value based on the detection value data stored in the storage. In this case, the determination result of the ECU 31 may be displayed on the display (notification device) provided in the vehicle 30. Further, the speaker (notification device) provided in the vehicle 30 may output a sound representing the determination result of the ECU 31 (event identification unit).

The driving diagnostic device 10 may be implemented with a configuration different from the above. For example, the first server 12, the second server 14, the third server 16, and the fourth server 18 may be realized by one server. In this case, the inside of the server may be virtually divided into areas corresponding to the first server 12, the second server 14, the third server 16, and the fourth server 18 using, for example, a hypervisor.

The driving diagnostic device 10 does not have to be connected to the Internet. In this case, for example, the detection value data group acquired from the vehicle is recorded on a portable recording medium (for example, a universal serial bus (USB)), and the detection value data group in the recording medium is copied to the first server 12 (data acquisition unit).

The third server 16 may have a function of confirming the access authority when the third server 16 receives an access from the fourth server 18. In this case, only when the third server 16 confirms that the fourth server 18 has the access authority, the fourth server 18 can receive the data related to the identified event from the third server 16.

A certain restriction may be applied to the access by the subject B (fourth server 18) to a part of the data recorded in the storage of the third server 16. For example, information indicating that the data is restricted data is added to a part of the data group recorded in the storage of the third server 16. An access by the subject B (fourth server 18) to the data to which the information indicating that the data is the restricted data is added is prohibited (even when the user has the above access authority). The data to which the information indicating that the data is the restricted data is added is, for example, the position information.

Instead of the OPS receiver 37, the vehicle 30 may include a receiver capable of receiving information from satellites of a global navigation satellite system (for example, Galileo) other than GPS.

The mobile terminal 50 may read the map data from the Web server and display the map image on the display unit 51.

What is claimed is:

1. A driving diagnostic device comprising:
a data acquisition unit that is able to acquire, from a vehicle, a detection value indicating that a turn signal lever provided in the vehicle is moved from a neutral position to an operation position and a specific acceleration that is at least one of a front-rear acceleration of the vehicle and a steering angular acceleration of a steering wheel provided in the vehicle; and
an event identification unit that determines whether a duration that is a time during which the turn signal lever is continuously positioned at the operation position is less than a first threshold value and whether an absolute value of the specific acceleration is equal to or more than a second threshold value based on the detection value and the specific acceleration acquired by the data acquisition unit.

2. The driving diagnostic device according to claim 1, further comprising a notification device that notifies a driver of the vehicle of a determination result by the event identification unit when the event identification unit determines that the duration is less than the first threshold value and the absolute value of the specific acceleration is equal to or more than the second threshold value.

3. The driving diagnostic device according to claim 1, wherein the data acquisition unit is a transmission-reception unit that is able to receive the detection value and the specific acceleration from the vehicle via the Internet and able to transmit the detection value and the specific acceleration that are acquired to the event identification unit.

4. The driving diagnostic device according to claim 1, further comprising a database unit that stores information on whether the duration is less than the first threshold value and whether the absolute value of the specific acceleration is equal to or more than the second threshold value determined by the event identification unit, and is connected to the Internet.

5. A driving diagnostic method comprising:
a step of acquiring, from a vehicle, a detection value indicating that a turn signal lever provided in the vehicle is moved from a neutral position to an operation position and a specific acceleration that is at least one of a front-rear acceleration of the vehicle and a steering angular acceleration of a steering wheel provided in the vehicle; and
a step of determining whether a duration that is a time during which the turn signal lever is continuously positioned at the operation position is less than a first threshold value and whether an absolute value of the specific acceleration is equal to or more than a second threshold value based on the detection value and the specific acceleration.
